(19) United States
(12) Patent Application Publication
(10) Pub. No.: US 2026/0178209 A1
(43) Pub. Date: Jun. 25, 2026

(54) STREAMING CONVERSION OF VIRTUAL DISK IMAGES FOR ORCHESTRATION AND MANAGEMENT OF HETEROGENEOUS COMPUTING RESOURCES

(71) Applicant: Hewlett Packard Enterprise Development LP, Spring, TX (US)

(72) Inventors: David Rabon Estes, Westfield, IN (US); Brian David Wheeler, Cherry Hills Village, CO (US)

(21) Appl. No.: 18/990,681

(22) Filed: Dec. 20, 2024

(51) Int. Cl. G06F 3/06

(52) U.S. Cl. CPC G06F 3/0647; G06F 3/0604; G06F 3/0667; G06F 3/0673

(57) ABSTRACT

A system and method for converting and copying a virtual disk image between provider-specific computing resources is provided. The method includes receiving a request to copy a virtual disk image from a source to a destination, and converting the virtual disk image from a source format to a destination format while copying. The conversion process involves predicting locations of data blocks within the virtual disk image based on structural characteristics of the source format without accessing metadata at the end of the image. Data blocks are decoded from the source format to a raw format while streaming from the source, based on the predicted locations. The data blocks are then encoded from the raw format to the destination format while streaming to the destination. This method enables efficient conversion and transfer of virtual disk images between different provider-specific computing resources.

### BACKGROUND

Cloud computing has revolutionized the way organizations manage and deploy IT resources. By providing on-demand access to a shared pool of configurable computing resources, cloud platforms enable organizations to rapidly scale their infrastructure and services without needing large upfront investments in hardware. These resources can include virtual machines, storage, networking, databases, and various software applications and services.

The cloud computing model typically encompasses several service categories, including Infrastructure as a Service (IaaS), Platform as a Service (PaaS), and Software as a Service (SaaS). IaaS provides virtualized computing resources over the internet, allowing users to rent virtual machines, storage, and networking. PaaS offers a platform for developers to build, run, and manage applications without the complexity of maintaining the underlying infrastructure. SaaS delivers software applications over the internet, eliminating users needing to install and run the applications on their computers or infrastructure.

As cloud adoption has grown, many organizations have embraced hybrid and multi-cloud strategies. Hybrid cloud environments combine public and private cloud resources, allowing businesses to keep sensitive data on-premises while leveraging the scalability and cost-effectiveness of public clouds for other workloads. Multi-cloud approaches involve using services from multiple cloud providers, which can help avoid vendor lock-in and optimize for specific capabilities offered by different platforms.

The management and orchestration of resources across diverse cloud environments can present significant challenges for organizations. Various tools and platforms have emerged to address these challenges. However, the rapidly evolving nature of cloud services and the increasing complexity of enterprise IT landscapes continue to present ongoing challenges in this domain.

### BRIEF DESCRIPTION OF THE DRAWINGS

For a more complete understanding of this disclosure, and advantages thereof, reference is now made to the following descriptions taken in conjunction with the accompanying drawings.

FIG. 1 is a block diagram of a cloud computing management environment, according to some implementations.

FIG. 2 is a block diagram of hardware components of the management platform, according to some implementations.

FIG. 3 is a block diagram of the software architecture of the management environment, according to some implementations.

FIG. 4 is a block diagram of a management method, according to some implementations.

FIG. 5 is a block diagram of the cloud computing management environment, according to some implementations.

FIG. 6 illustrates a virtual disk format conversion process within the management environment, according to some implementations.

FIG. 7 illustrates a flowchart of a virtual disk image converting method, according to some implementations.

FIG. 8 illustrates a flowchart of a virtual disk image converting method, according to some implementations.

Corresponding numerals and symbols in the different figures generally refer to corresponding parts unless otherwise indicated.

### DESCRIPTION

The following disclosure provides many different examples for implementing different features. Specific examples of components and arrangements are described below to simplify the present disclosure. These are, of course, merely examples and are not intended to be limiting.

Modern enterprise IT environments often encompass heterogeneous computing resources spanning multiple cloud providers, on-premises infrastructure, and various software-as-a-service offerings. Managing and orchestrating these diverse resources may present challenges for organizations.

In heterogeneous environments, organizations may need to move or copy virtual machines between different providers, which may use different hypervisors. However, different hypervisors may use incompatible virtual disk formats, making it difficult to transfer virtual disk images between providers. Conventional methods of converting virtual disk images between disk formats can be time-consuming and resource-intensive, often using significant storage space to create converted copies of the disk image.

This disclosure describes a system and method for streaming conversion of virtual disk images between heterogeneous computing environments. The system enables on-the-fly conversion of virtual disk images from one format to another while streaming the disk between source and destination environments. This approach eliminates the need for intermediate storage and conversion of the disk to different formats, reducing the time and resources used to convert virtual machine disk images when they are transferred between different providers.

The streaming conversion algorithm utilizes a predictive approach to interpret the structure of the source virtual disk format without relying on metadata typically found at the end of the virtual disk image. By analyzing the structural characteristics of the source format, the system can infer the locations of data blocks within the virtual disk image during streaming of the image. This allows for efficient streaming and conversion of the disk image, and may avoid the need to read the entire disk image (including the metadata at the end of the image) before conversion can begin.

As disk image data is streamed from the source, the system decodes the virtual disk from its source format into a raw format using the predictive algorithm. Furthermore, it encodes the raw formatted data into the destination format and streams it to the target environment. In some implementations, the encoding may be performed along with the decoding, which may potentially avoid buffering large amounts of the disk data. This process may occur nearly in real-time, allowing for rapid transfer and conversion of the virtual disk image.

The streaming conversion approach offers benefits to organizations managing heterogeneous computing environments (specifically, heterogeneous virtualization environments). It reduces the time and storage resources required for virtual machine migrations between providers, enables more flexible use of multi-cloud and hybrid cloud architectures, and simplifies the process of moving workloads between different environments. By streamlining the transfer and conversion of virtual disk images, the system helps organizations manage and orchestrate their diverse computing resources, improving operational efficiency in complex IT landscapes. Additionally, this approach may help organizations avoid virtualization vendor lock-in by enabling easier migration between different hypervisor platforms.

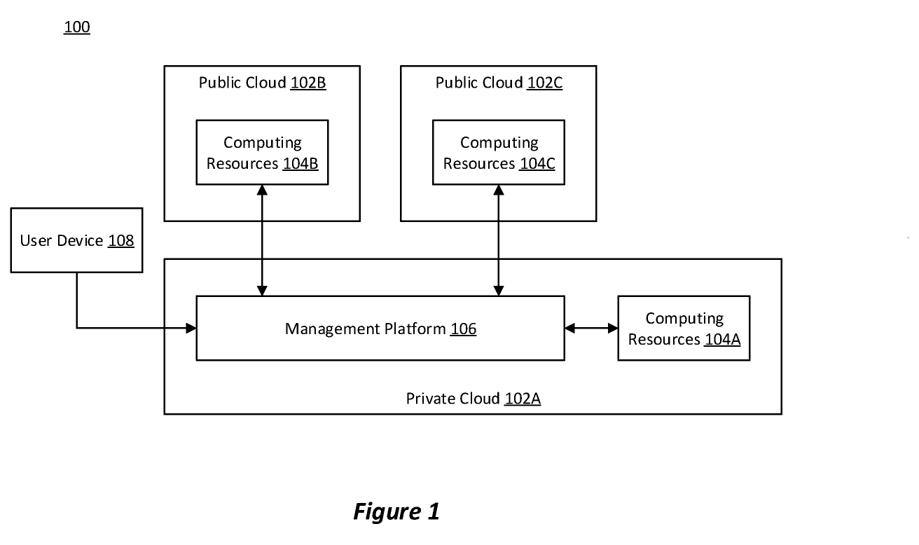

FIG. 1 is a block diagram of a cloud computing management environment 100, according to some implementations. The management environment 100 may include multiple clouds 102 (including a private cloud 102A and one or more public clouds 102B, 102C), a management platform 106, and a user device 108. This architecture represents a hybrid cloud approach for an organization, combining private and public cloud resources under centralized management while maintaining data privacy and security.

The private cloud 102A may be a privately accessible computer network under the organization’s control. In some aspects, it may provide dedicated computing resources and infrastructure that are not shared with other organizations. The private cloud 102A may offer enhanced security and customization options compared to public cloud offerings. In some cases, it may allow the organization to maintain sensitive data and critical workloads on-premises while still leveraging cloud technologies and architectures. The private cloud 102A may be managed and operated by the organization’s IT staff, providing greater control over resource allocation, security policies, and compliance measures.

The public clouds 102B, 102C may be publicly accessible computer networks operated by cloud providers. In some aspects, they may provide shared computing resources and infrastructure that can be utilized by multiple organizations. The public clouds 102B, 102C may offer organizations scalable and on-demand access to computing power, storage, and various services. In some cases, they may allow organizations to rapidly provision resources without large upfront investments in hardware and infrastructure. The public clouds 102B, 102C may be managed and operated by third-party cloud service providers, offering services and APIs for resource allocation and management. In some implementations, they may provide built-in redundancy and geographic distribution of resources to enhance reliability and performance. The public clouds 102B, 102C may be operated by different service providers, allowing organizations to leverage the unique strengths and capabilities of multiple cloud platforms.

The clouds 102 include computing resources 104 (e.g., computing resources 104A, computing resources 104B, and computing resources 104C for, respectively, the private cloud 102A, the public cloud 102B, and the public cloud 102C). The computing resources 104 may include various types of resources that can be utilized to perform computational tasks, store data, and the like. In some aspects, these resources may include virtual machines, containers, serverless functions, storage volumes, databases, networking components, and other cloud-based services. The computing resources 104 may be dynamically scalable, allowing for flexible allocation based on demand. In some cases, the computing resources 104 may include specialized hardware such as GPUs for machine learning tasks or FPGAs for custom acceleration. The computing resources 104 may also encompass platform services like managed Kubernetes clusters, serverless platforms, or IoT device management systems. Additionally, the computing resources 104 may include software-defined infrastructure components that can be programmatically controlled and configured. The specific types and configurations of computing resources 104 may vary between the private cloud 102A and public clouds 102B and 102C, reflecting the different capabilities of each environment.

The management platform 106 may serve as a central control point in the management environment 100, coordinating interactions between the various components (including the computing resources 104). In some implementations, the management platform 106 may be deployed within the private cloud 102A. In other implementations, the management platform 106 may be deployed within another part of an organization. The management platform 106 may control the computing resources 104A within the private cloud 102A and the computing resources 104B, 104C in the public clouds 102B, 102C. Specifically, the management platform 106 may send instructions to and receive information from the computing resources 104, which may allow for efficient allocation and management of resources across the clouds 102.

In some cases, the hybrid architecture of the management environment 100 may enable the organization to maintain sensitive workloads and data within their private cloud 102A while leveraging the scalability and cost-effectiveness of public clouds 102B, 102C for other operations. The management platform 106 may provide a unified view of the computing resources 104, regardless of location, allowing for consistent policies and management practices across the entire environment.

The user device 108 may be connected to the management platform 106, allowing users to interact with and control the management platform 106. This may enable administrators to manage computing resources 104 across private and public clouds from a single interface, streamlining operations and reducing complexity. This may also enable end-users (e.g., non-administrators) to access computing resources 104 as permitted by their roles and permissions. Specifically, the management platform 106 may provide self-service capabilities for end-users to provision and manage resources within defined policies and limits set by administrators.

The management platform 106 may provide a unified view of resources across multiple cloud providers and on-premises infrastructure. This unified view may allow an administrator using a user device 108 to monitor and manage the computing resources 104 across the private cloud 102A and public clouds 102B, 102C from a single interface. In some aspects, the management platform 106 may aggregate data from various sources and present it in a consistent, normalized format, enabling users to easily compare and analyze resource utilization across different environments. The normalization process may involve transforming definitions for provider-specific computing resources 104 into defined schemas, creating a standardized representation of diverse resource types. This transformation may allow the management platform 106 to handle heterogeneous data from different cloud providers and on-premises systems uniformly. The defined schemas may capture the requisite attributes and relationships of resources, enabling the platform to maintain a coherent view of the entire infrastructure landscape. By normalizing the data, the management platform 106 may facilitate cross-provider comparisons, simplify resource management tasks, and provide a foundation for advanced analytics and optimization strategies.

In addition to unified visibility, the management platform 106 may offer unified control of the computing resources 104. The platform may leverage APIs provided by the computing resources 104 to enable centralized management and orchestration. This unified control may allow administrators to perform actions such as provisioning, scaling, and configuring resources across multiple environments from a single point of control. The management platform 106 may abstract away the particularities of individual provider interfaces, presenting a consistent set of management operations that can be applied across heterogeneous computing resources 104. This unified control approach may streamline management and orchestration operations, including day-2 operations.

The management platform 106 may discover and inventory computing resources 104 across the clouds 102. This discovery process may involve periodic scanning and synchronization to maintain an up-to-date view of available resources. The platform may automatically detect new resources, changes to existing resources, and resource removals across both private cloud 102A and public clouds 102B, 102C. The discovered computing resources 104 may be mapped to a normalized data model (subsequently described) for the platform, enabling consistent representation regardless of the source cloud. The discovery process may capture detailed metadata about computing resources 104, including relationships between resources, configuration settings, and operational state. This comprehensive resource discovery may enable the management platform 106 to maintain an accurate inventory of infrastructure components and their dependencies across the entire management environment 100.

The management platform 106 may manage user access and authentication within the system. This functionality may allow administrators to control the resources and capabilities end-users can access through the user devices 108. The platform may implement role-based access control (RBAC) to define and manage user permissions across the entire management environment 100, ensuring that users are limited to having access to the resources and functions appropriate for their roles. In some implementations, the management platform 106 may layer a user authentication and authorization framework over existing frameworks (if any) of the computing resources 104. For example, the management platform 106 may have a master API key to a computing resource 104 and may control how the computing resources 104 are accessed by users based on its own authentication and authorization system. The platform may map user identities and roles across different systems, providing a unified access model that spans heterogeneous environments. In some cases, the management platform 106 may integrate with existing authentication systems, enabling single sign-on capabilities.

The management platform 106 may implement a comprehensive security and compliance framework across the management environment 100. This framework may include automated security scanning of computing resources 104, continuous compliance monitoring, and policy enforcement during resource provisioning and management. The platform may integrate with security tools and services to perform vulnerability assessments, configuration audits, and security monitoring of resources across clouds 102. In some implementations, the management platform 106 may enforce security policies during provisioning, automatically configuring security controls and validating compliance requirements as resources are deployed. The platform may maintain audit trails of actions performed on computing resources 104, enabling organizations to track changes and demonstrate compliance with security requirements. Security policies may be defined and enforced consistently across the private cloud 102A and the public clouds 102B, 102C, ensuring uniform security controls regardless of resource location.

The management platform 106 may provide self-service capabilities to users of the user device 108. An end-user may request and provision resources through a user device 108 within predefined limits and policies set by administrators. In some aspects, the management platform 106 may present different interfaces or options to users based on their roles or permissions, allowing for customized self-service experiences while ensuring compliance with organizational policies. The self-service capabilities may be constrained by configuration settings defined within the management platform 106 by the organization. For example, administrators may set resource quotas, cost thresholds, or approved computing resources 104 that limit what end-users can provision. The management platform 106 may enforce these constraints automatically when processing self-service requests. Additionally, the management platform 106 may provide approval workflows for certain requests requiring additional authorization before provisioning. This allows organizations to enable user-driven provisioning while maintaining appropriate governance and control over resource usage. The platform may support contextually aware deployments, considering user permissions and group participation when determining where and how to provision resources.

The management platform 106 may implement an application-centric approach to resource management, allowing for the orchestration of complete application stacks rather than individual infrastructure components. This approach may allow users to request and manage entire applications, with the platform automatically determining and provisioning suitable computing resources 104 for the application across appropriate clouds 102, as specified by organizational policies and system configurations. The management platform 106 may maintain application context throughout the resource lifecycle, understanding relationships between application components and their supporting infrastructure. In some implementations, the management platform 106 may provide application-level monitoring, scaling, and lifecycle management capabilities. This application-centric model may abstract away infrastructure complexity, allowing users to focus on orchestrating and managing applications while the platform handles the orchestration of underlying resources and day-2 aspects. The management platform 106 may track application dependencies and requirements, using this information to make intelligent decisions about resource placement and configuration across the private cloud 102A and public clouds 102B, 102C.

The management platform 106 may provide streamlined lifecycle management of applications, from initial deployment through scaling and updates. This may include capabilities for monitoring application performance, automating scaling operations, and managing updates or patches. Users may be able to manage the entire application lifecycle through a user device 108, with the management platform 106 coordinating the requisite actions across the relevant computing resources 104 in the private cloud 102A or public clouds 102B and 102C.

The management platform 106 may integrate with various external tools and services that support the computing resources 104. These integrations may include IP address management (IPAM) systems for network address allocation, load balancers for traffic distribution, monitoring tools for performance tracking, backup systems for data protection, security scanners for vulnerability detection, domain name system (DNS) providers for name resolution, and the like. The management platform 106 may coordinate with these external tools and services during orchestration and management. For example, when configuring a computing resource 104 as part of an application’s orchestration, the management platform 106 may interact with an IPAM system to allocate an IP address, a DNS provider to register a hostname, and a load balancer to configure traffic routing. The platform may maintain associations between computing resources 104 and related external services throughout the resource lifecycle, ensuring proper cleanup and resource release when resources are decommissioned. These integrations may be configured at the organization level and may apply across resources in both the private cloud 102A and public clouds 102B, 102C.

The management platform 106 may provide capabilities for tracking and metering resource usage to enable cost management and optimization. This may involve collecting detailed usage data from the computing resources 104 across the clouds 102 and presenting it in a unified format. The platform may aggregate costs and bills from the various computing resources 104 to provide consolidated financial reporting. In some aspects, the management platform 106 may implement FinOps practices to align technology spending (on the computing resources 104) with business objectives of the organization. Users may access this data through a user device 108, gaining improved visibility into resource utilization and dependencies across the entire IT landscape. The management platform 106 may provide user interfaces for analyzing this data, helping users identify opportunities for cost optimization or efficiency improvements. In some cases, the platform may enable chargeback or showback reporting to allocate costs to specific business units or projects.

The management platform 106 may provide a comprehensive, provider-agnostic API that enables users to script and automate operations across heterogeneous cloud environments. This API may abstract away the differences between various cloud providers and on-premises systems, presenting a unified interface for managing computing resources 104 regardless of their location or underlying technology. Through this API, users can programmatically control aspects of resource provisioning, configuration, and lifecycle management across the private cloud 102A and public clouds 102B, 102C using consistent commands and data structures. In some implementations, the API may support various programming languages and offer client libraries to facilitate integration with existing tools and workflows. The provider-agnostic nature of the API may allow organizations to develop portable automation scripts and tools that can operate across different cloud environments without modification, reducing vendor lock-in and enhancing flexibility in multi-cloud strategies. These programmatic interfaces may enable advanced automation scenarios, support infrastructure-as-code practices, and facilitate integration with continuous integration and continuous delivery pipelines as well as other DevOps tools.

The management platform 106 may normalize data from heterogeneous sources into a common data model. Example sources of data may include data from computing resources 104 across the clouds 102, financial systems, management tools, and the like. This normalization may enable the management platform 106 to orchestrate workflows that span multiple environments and domains, considering the unique characteristics and capabilities of each resource type.

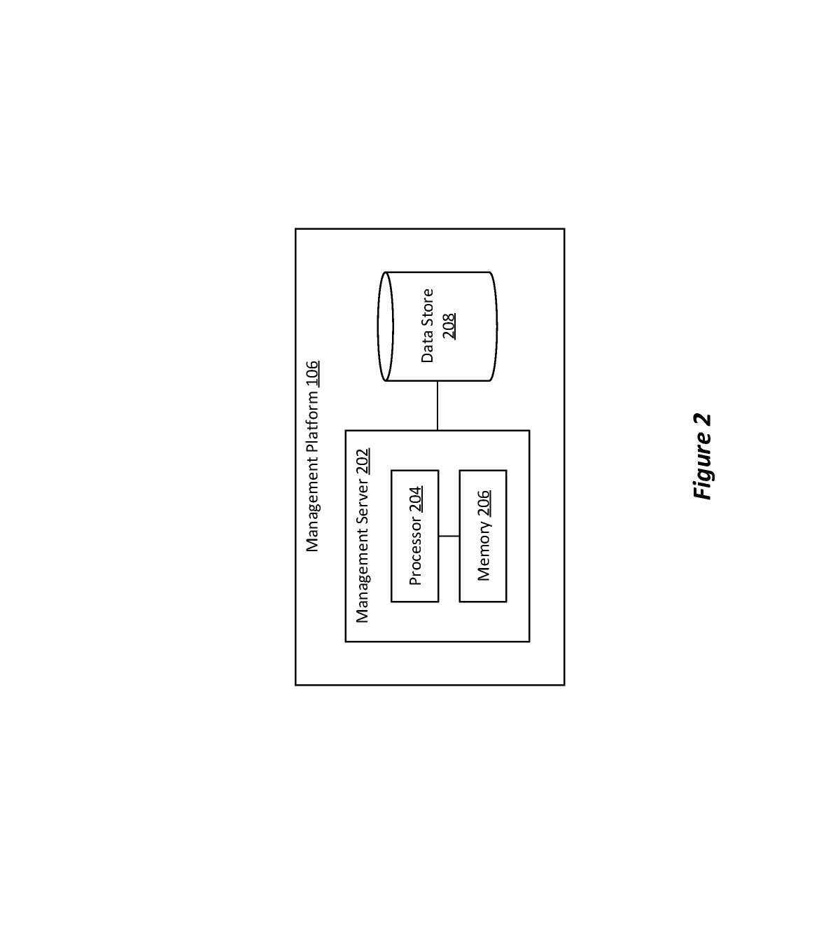

FIG. 2 is a block diagram of hardware components of the management platform 106, according to some implementations. The management platform 106 may include one or more management servers 202 and one or more data stores 208. Only one management server 202 and data store 208 are shown in this example.

In some aspects, the management server 202 may serve as a central component of the management platform 106, performing administrative functions. These functions may include managing and/or orchestrating provider-specific computing resources, normalizing heterogeneous data, processing service requests, and the like.

The management server 202 may include suitable components for performing any desired functionality. One or more modules within the server may be partially or wholly embodied as software and/or hardware for performing any functionality described herein. For example, a server may include a processor 204 and a memory 206. The processor 204 may be a microprocessor, an application-specific integrated circuit, a microcontroller, or the like. The memory 206 may be a non-transitory computer-readable medium that stores instructions for execution by the processor 204. The instructions, when executed by the processor 204, may cause the processor to perform any functionality described herein.

The data store 208 may provide storage capacity for maintaining data related to the managed resources and services. In some aspects, the data store 208 may include database servers, file servers, network-attached storage (NAS) devices, or the like for storing the normalized data representing heterogeneous provider-specific computing resources. The data store 208 may be implemented using various storage technologies, such as relational databases, NoSQL data stores, distributed file systems, object storage, block storage, or the like depending on the specific requirements of the management platform 106.

In some cases, the management platform 106 may include redundant components or distributed architectures to provide high availability and fault tolerance. For example, the management server 202 may be implemented as a cluster of servers, with the workload distributed across multiple physical or virtual hosts. Likewise, the data store 208 may be implemented using a distributed database system to achieve data redundancy and availability. The management platform 106 may also incorporate load balancing mechanisms to distribute incoming requests across multiple servers.

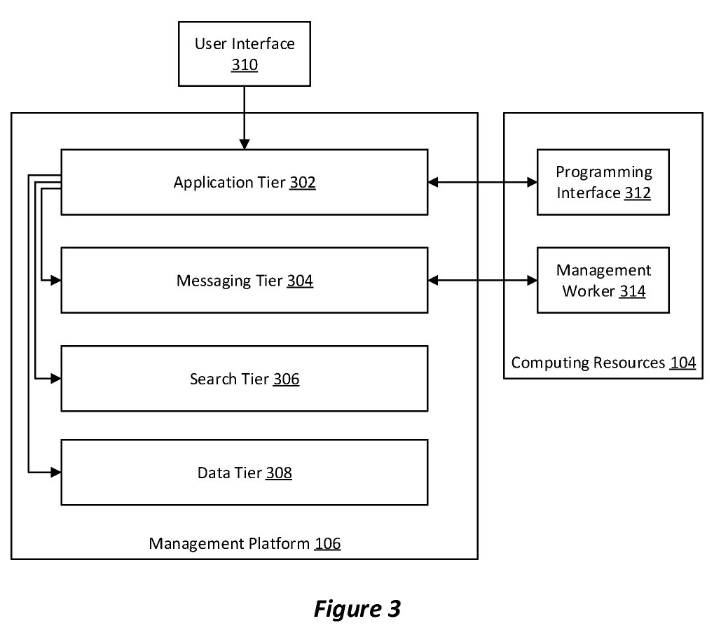

FIG. 3 is a block diagram of the software architecture of the management environment 100, according to some implementations. The diagram illustrates the various software components and tiers that make up the management platform 106 and the computing resources 104.

The management platform 106 may be implemented using a tiered architecture to organize its functionality. This architecture may include an application tier 302, a messaging tier 304, a search tier 306, and a data tier 308. The management platform 106 may include more or fewer tiers than shown in this example. The specific number and organization of tiers may vary depending on the requirements and design choices of the system.

The application tier 302 may form the core of the management platform 106, handling the primary business logic and orchestration tasks. The application tier 302 may control the other tiers within the management platform 106: the messaging tier 304, the search tier 306, and the data tier 308. In some aspects, the application tier 302 may include software applications for processing service requests, orchestrating resources, managing workflows, and the like. The application tier 302 may interact with external computing resources 104 and may coordinate activities across different cloud environments. In some implementations, the application tier 302 may be built using a microservices architecture, allowing for scalability and flexibility. The application tier 302 may leverage data stored in the data tier 308 (e.g., using a normalized data model) to make intelligent decisions about resource allocation and configuration. In some implementations, the application tier 302 may run nginx for serving a web interface, Apache Tomcat for handling business logic, and Apache Guacamole for providing remote access and control capabilities. Other applications may run in the application tier 302.

The messaging tier 304 may facilitate communication between different components of the management platform 106 and external systems. The messaging tier 304 may implement a publish-subscribe model or utilize protocols such as Advanced Message Queuing Protocol (AMQP), running a message broker like RabbitMQ, to provide reliable and asynchronous communication between various components of the management platform 106 and computing resources 104. In some aspects, the messaging tier 304 may include a load balancer that receives messages from the application tier 302 and distributes them to message brokers.

The search tier 306 may provide indexing and search capabilities for the management platform 106. This tier may enable efficient querying and retrieval of information across the normalized data model stored in the data tier 308. In some implementations, the search tier 306 may utilize a non-transactional database such as Elasticsearch to provide high-performance full-text search and analytics capabilities. The use of Elasticsearch or similar technologies may allow for rapid searching and aggregation of large volumes of data from heterogeneous sources. This search functionality may support various operations within the management platform 106, such as resource discovery, monitoring, and reporting. The search tier 306 may index data from multiple sources, including the normalized data model, logs, and metrics, to provide a unified search interface across the entire management environment.

The data tier 308 may be responsible for data storage and management within the management platform 106. This tier may implement a normalized data model that represents the heterogeneous provider-specific computing resources in a standardized format. In some aspects, the data tier 308 may utilize a transactional database (such as MySQL, PostgreSQL, or the like) to store and manage the normalized data. Using a transactional database may provide Atomicity, Consistency, Isolation, and Durability (ACID) properties, ensuring data integrity and reliability. This may be particularly important when dealing with complex relationships and dependencies between heterogeneous resources. The data tier 308 may handle database operations such as inserting, updating, and querying the normalized data, providing a consistent and reliable data layer for the other tiers of the management platform 106.

The management platform 106 may provide a user interface 310, serving as the entry point for user interactions with the system. The user interface 310 may connect directly to the application tier 302, allowing users to initiate management and orchestration tasks, view resource status, and access other platform features.

A computing resource 104 may implement various mechanisms for interacting with the management platform 106. A programming interface 312 may provide programmatic access to the platform’s functionality. The programming interface 312 may represent an API provided by a cloud provider, enabling the management platform 106 to interact with and control resources in that provider’s environment. When the management platform 106 interacts with the computing resources 104 via a programming interface 312, the application tier 302 may directly access the programming interface 312, such as via web API requests.

A management worker 314 may be executed in the computing resources 104 and may interact with the management platform 106 through messaging. The management worker 314 may be a custom application executing in the cloud provider’s environment. In some aspects, the management worker 314 may be a system process running on a computing device (e.g., a physical or virtual host). In some aspects, the management worker 314 may process tasks or messages and facilitate interactions between the management platform 106 and the specific cloud environment by sending information to the management platform 106. For example, the management platform 106 may interact with the computing resources 104 by sending messages to the management worker 314 via the messaging tier 304.

In some implementations, the management worker 314 may act as an intermediary between the management platform 106 and agents running on the computing resources 104. The management worker 314 may perform certain tasks as delegated thereto by the management platform 106. For instance, the management worker 314 may collect data from the computing resources 104 and return it to the management platform 106. The management worker 314 may also orchestrate components of the computing resources 104 based on instructions received from the management platform 106.

The management worker 314 may aggregate and multiplex communications from multiple agents running on computing resources 104 within a provider. This may potentially reduce the number of network connections to the management platform 106 from the provider. In some cases, the management worker 314 may facilitate remote host console access to the agents in the computing resources 104, act as a proxy for cloud provider APIs, and dynamically execute plugin code to perform local processing and optimization. This approach may allow organizations to manage resources across multi-cloud environments more efficiently, while maintaining security and potentially reducing network overhead.

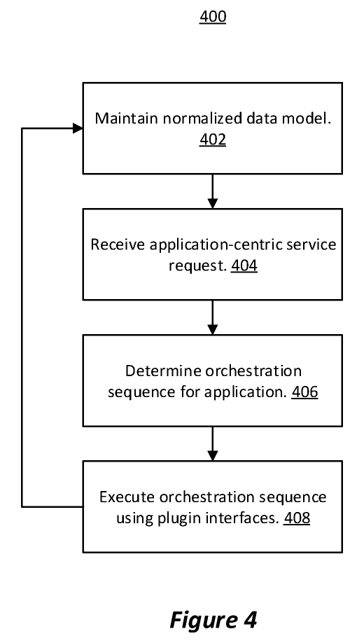

FIG. 4 is a block diagram of a management method 400, according to some implementations. The management method 400 will be described in conjunction with the management environment 100 of FIGS. 1-3. The management method 400 may be used for managing and orchestrating heterogeneous cloud resources through a normalized data model. The management method 400 may be implemented in the management environment 100. Specifically, the management platform 106 may perform the management method 400.

At step 402, the management platform 106 maintains a normalized data model of heterogeneous data from the provider-specific computing resources 104. The normalized data model may be built by obtaining heterogeneous data from various providers, which data is then normalized into the normalized data model. For example, the management platform 106 may perform data normalization in the application tier 302. In some implementations, the normalizing of the heterogeneous data is performed by the management platform 106. The normalization process transforms diverse definitions of computing resources 104 into defined schemas representing relationships and dependencies across different computing resources 104, regardless of origin. Thus, the management platform 106 has a common format for describing and managing computing resources 104 from any provider.

For example, the normalization process can include converting various configurations (of virtual machines, IP address managers, etc.) into common formats that generically represent the configurations. For example, the management platform 106 may convert VMware-specific virtual machine attributes, AWS-specific instance properties, or InfoBlox IPAM configurations into their respective common representation. In the case of resource allocation, what may be called a resource pool in VMware, a VPC in Amazon, or a resource group in Azure, can be normalized into a common representation in the data model. The normalization may preserve provider-specific features while maintaining common denominator functionality across providers. Continuing the previous example, configurations of an IP address management tool like InfoBlox can be normalized such that network resources work seamlessly with network configurations from various cloud providers without requiring custom integration code for each combination.

The normalized model maintains relationships between components while preserving provider-specific capabilities, enabling cross-service interactions through common data abstractions. The model tracks relationships between applications and supporting infrastructure, enabling services that don’t natively know about each other to interact through the normalized data model. The normalization allows the system to represent, for example, a virtual machine and a container in a common format, facilitating the management of resources across different technological paradigms through a common abstraction layer.

The normalized data model is stored in a database. For example, the management platform 106 may store the normalized data in the data tier 308. The stored model captures resource relationships, dependencies, and configurations in a format that can be efficiently queried and updated by the application tier 302. The data tier 308 may leverage a transactional database to maintain data integrity across the normalized representations. The transactional database schema includes tables that normalize infrastructure components and their relationships in the management environment. For example, a virtual machine may be represented in one table and the virtual machine’s network card may be represented in another table, with the network card’s IP address and connected switch tied off in related tables through the normalized data model. The structure tracks relationships and dependencies across heterogeneous resources while maintaining data consistency.

The data tier 308 interacts with the application tier 302 through database operations for storing and retrieving normalized data. The messaging tier 304 coordinates communication between the data tier 308 and other components through, for example, message queues, enabling asynchronous data operations. The search tier 306 may utilize a non-transactional database, such as Elasticsearch, to index the normalized data, enabling high-performance searching and aggregation across the normalized model.

The search tier 306 provides indexing and search capabilities across the normalized data model stored in the data tier 308. This enables efficient querying and retrieval of information about resources, relationships, and configurations stored in the data tier 308. The search functionality, provided by the search tier 306, supports various operations within the management platform 106, such as resource discovery, monitoring, and reporting.

The heterogeneous data may be collected by the management platform 106 through various approaches. In some cases, the application tier 302 may directly interact with the programming interface 312 of the computing resources 104 to gather data. This approach may involve making API calls to cloud provider services or on-premises systems to retrieve information about resource configurations, states, and relationships. Alternatively, the messaging tier 304 may collect data by communicating with the management worker 314 deployed within the computing resources 104.

The management worker 314 may aggregate data from multiple agents or resources within its environment and send this information to the messaging tier 304 using a messaging protocol. In some implementations, the management worker 314 may directly interact with resources that do not have a programming interface 312 usable by the application tier 302. For example, the management worker 314 may use provider-specific libraries or classes, from a provider-specific Software Development Kit (SDK), to communicate with resources and collect data, then relay that information back to the management platform 106 for normalization and storage. Additionally or alternatively, the management worker 314 may interact with the programming interface 312 (when available) of a resource. The combination of these approaches may allow the management platform 106 to gather comprehensive data about heterogeneous resources across diverse environments, even when those resources are legacy components that may not offer a programming interface usable by the management platform 106.

At step 404, a service request for application deployment is received through, for example, a user interface or programming interface. In some aspects, the management platform 106 may provide self-service capabilities, allowing end-users to request and provision applications. The application tier 302 may receive the service request through the user interface 310. The service request may specify application requirements that span multiple provider-specific computing resources. Using the normalized data model maintained at step 402, the management platform 106 can process the application deployment request based on the request’s context, such as whether the request comes from a QA department or production environment.

Thus, the management platform 106 implements an application-centric approach to resource management, allowing for the self-service orchestration of complete application stacks rather than individual infrastructure components. This approach allows end-users to request and manage entire applications, with the platform automatically determining and provisioning suitable computing resources for the application across appropriate clouds, as specified by organizational policies and system configurations. For example, a service request may request deployment of a multi-tier application. Based on the normalized data model, organization policies, and configurations, the management platform 106 may determine requisite compute resources to deploy the requested application. For example, the management platform 106 may form an orchestration plan that specifies compute resources from VMware, a network configuration via InfoBlox, and a load balancer configuration. In another example, a request may specify deploying a WordPress application, which requires the management platform 106 to identify and coordinate components, including web servers, database servers, storage, and network configurations. When deploying a web application, the request may specify requirements for a web server and a database server, where the database server is to be provisioned before the web server due to dependency requirements. The normalized data model enables the management platform 106 to deploy components in a way that makes them work together even though they don’t natively know about each other.

At step 406, the management platform 106 determines an orchestration sequence to handle the service request. The requests are processed through the normalized data model to identify the requisite resources and dependencies. The normalized model enables the management platform 106 to understand the requisite individual resources and their relationships and dependencies across different providers. Organization policies and the end-user’s request context may also influence orchestration.

The management platform 106 determines resource placement and configuration based on the application context and organizational policies. For example, the same application service request might result in different resource allocations and configurations depending on whether it’s for development, testing, or production use. This may include deploying to specific cloud providers or resource pools based on the requesting group’s role or applying different backup, monitoring, and security policies based on the deployment context. For example, when a QA team requests a testing environment, the management platform 106 may deploy resources to a lower-cost environment with different performance characteristics than a production deployment request from an operations team. The normalized data model allows contextual deployment by enabling different orchestration workflows to be seamlessly created and executed for each deployment environment or context transparently to the end-user.

The normalized data model enables the platform to maintain contextual differences using the same underlying resource definitions and relationships. In some aspects, the normalized model may transform complex orchestration processes into automated workflows. What traditionally requires multiple teams and extended timeframes can potentially be orchestrated as an automated sequence completed in minutes through the management platform 106.

At step 408, the management platform 106 executes the orchestration sequence. The orchestration may leverage the messaging tier 304 to coordinate actions across distributed resources. The normalized data model can enable the management platform 106 to sequence operations, such as allocating IP addresses before configuring network interfaces or deploying database instances before web servers. The orchestration process may include configuring day-2 operations such as backups, compliance automation, and security scan schedules.

The management platform 106 may utilize programming interfaces 312 and/or a management worker 314 within the computing resources 104 to orchestrate provider-specific computing resources in manners expected by each provider. In some implementations, a management worker 314 may receive commands from the management platform 106 through the messaging tier 304 to execute provider-specific operations. When provisioning resources, the management worker 314 may create a secure connection back to the management platform 106 and establish a command bus for coordinating actions between the platform and provider environments. The management worker 314 can operate behind load balancers for scalability and to process cloud API requests from remote locations. The management worker 314 may interact with computing resources 104 using provider-specific libraries or through the programming interface 312, allowing for flexible integration with various cloud environments and legacy systems. In some implementations, the management platform 106 may directly orchestrate resources via the programming interfaces 312 (when available) instead of using a management worker 314.

The management platform 106 utilizes a plugin architecture that generates plugin interfaces for service providers. The plugin architecture may create code templates with predefined integration points, allowing providers or end-users to implement their specific functionality while maintaining consistent interaction with the normalized data model. For example, an end-user may integrate an IPAM with the management platform 106 by creating a plugin for the IPAM. To create the plugin, the system can generate a code skeleton with defined methods that the provider fills in to allocate resources (e.g., IP addresses) or perform other specific operations. The orchestration sequence may be performed using the plugin interfaces.

The plugins are loaded at runtime through an isolated class loader, potentially within a JVM running in the application tier 302. Each plugin implements common interfaces that are clearly defined through Java documentation. The management platform 106 provides a context that allows plugins to call back into the platform and save data from computing resources 104 in the normalized format.

The database schema within the data tier 308 may support the plugin architecture by providing standardized ways to store and retrieve normalized data. When plugins interact with the management platform 106, they can store their data in the normalized format through defined interfaces, allowing the data to be used consistently across the platform regardless of the original provider format.

The plugin architecture enables runtime extension of computing resources 104 integration without modifying the core code of the management platform 106. Developers can use the generated plugin code templates when integrating new providers rather than writing custom integration code. The plugin framework handles the communication and data transformation between the provider-specific implementations (of the computing resources 104) and the normalized data model, allowing new integrations to leverage existing abstractions of the management platform 106.

The management platform 106 may orchestrate provider-specific computing resources by leveraging the normalized data model and plugin interfaces. During orchestration, the platform may invoke relevant plugins to interact with specific provider APIs or services. These plugins may translate orchestration commands from the normalized model into provider-specific API calls, allowing the management platform 106 to manage diverse resources through a unified programming interface. For example, when allocating storage, a plugin for a particular cloud provider may convert a generic storage request into the appropriate API calls for that provider’s block storage service. The plugin architecture may allow the orchestration process to seamlessly integrate new providers and resource types without modifying the core orchestration logic, enhancing the platform’s extensibility and adaptability to evolving cloud ecosystems.

The management platform 106 runs code from the plugins that interfaces with provider-specific APIs (e.g., VMware, InfoBlox, etc.) of the computing resources 104. At the same time, the normalized data model in the data tier 308 maintains the standardized representation of the operations. For example, a management worker 314 may execute provider-specific API calls to InfoBlox when allocating an IP address. Still, the results of those API calls are transformed and stored in the normalized model, enabling other components to interact with that IP address assignment without understanding InfoBlox-specific implementations.

The orchestration process can adjust its flow based on each step’s outcomes. For instance, if a call to a third-party policy API indicates additional requirements that call for extra steps in the orchestration process, the management platform 106 can inject the additional steps into the orchestration workflow. Each step in the orchestration flow has the capability of affecting subsequent steps, allowing for dynamic adaptation based on runtime conditions.

For application lifecycle management, the orchestration by the management platform 106 may include deploying various components and configuring day-2 operations. This may include deploying application code, obtaining an IP address, configuring monitoring systems, and setting up load balancer automation. When the application instance is decommissioned at the end of its lifecycle, the orchestration achieves proper cleanup, such as releasing the IP address for reuse. Throughout the application lifecycle, the process leverages the normalized data model to coordinate actions across different service providers while maintaining consistency through standardized interfaces. The management platform 106 handles both aspects of orchestration, including initial deployment and eventual teardown, providing comprehensive lifecycle management for applications across heterogeneous environments. The orchestration process through the normalized data model may transform what traditionally requires multiple teams and extended timeframes into an automated sequence of operations that may be provided in a self-service manner to end-users.

Following the orchestration operations, the normalized data model may be updated to reflect changes implemented during orchestration. In implementations, the data tier 308 performs the updating operation. For example, when an IP address is allocated during orchestration, the normalized model is updated to reflect this IP address allocation and its relationships to other resources. The updates maintain the accuracy of resource states, relationships, and configurations across the heterogeneous environment.

The search tier 306 may index the updates to enable efficient querying of the current environment. The indexing allows the management platform 106 to discover and monitor the environment, synchronizing changes to maintain an accurate inventory of infrastructure components and their dependencies. The management platform 106 can discover existing resources in the cloud and continue synchronizing any changes on a near real-time basis for provisioned resources.

The updated model can provide a foundation for subsequent orchestration operations, ensuring decisions are based on the current infrastructure state. For example, when an application instance is later modified or removed, the management platform 106 can use the updated model to understand related components that need to be reconfigured or cleaned up, such as releasing IP addresses or updating load balancer configurations. The discovery process can include monitoring installed software packages, which can be used for security scanning and compliance verification.

Maintaining, orchestrating, and updating the normalized data model establishes a continuous feedback loop where the model evolves with the infrastructure. This enables the management platform 106 to maintain consistency across heterogeneous resources while supporting complex orchestration scenarios. The normalized model allows provider-specific computing resources to interact through common interfaces while preserving their unique capabilities and requirements.

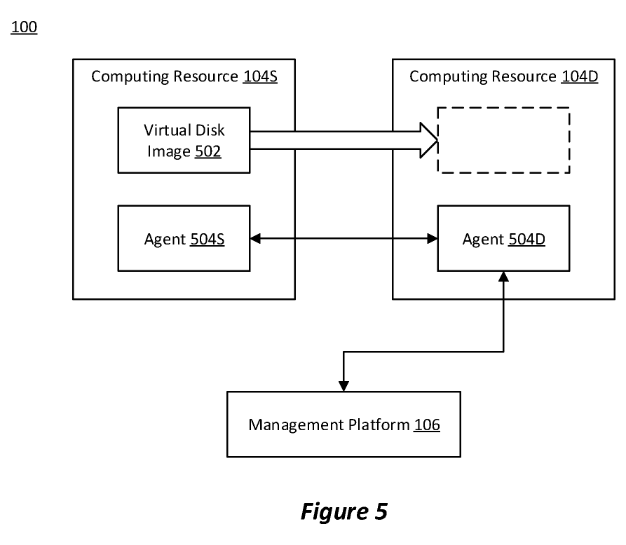

FIG. 5 is a block diagram of the cloud computing management environment 100, according to some implementations. In particular, FIG. 5 illustrates the flow of data within the management environment 100 when converting and copying a virtual disk image 502 between computing resources 104 (as indicated by dashed lines). The virtual disk image 502 is converted and copied from a source computing resource 104S to a destination computing resource 104D, under the direction of the management platform 106.

In some implementations, the copying of the virtual disk image 502 may be performed as part of the management and orchestration operations discussed for step 408 (see FIG. 4). The management platform 106 may coordinate the conversion and copying process via agents of the source computing resource 104S and the destination computing resource 104D. This process may involve determining the appropriate orchestration sequence based on the normalized data model, and then executing that sequence (potentially using plugin interfaces, previously described) to interact with the source computing resource 104S and the destination computing resource 104D. The virtual disk image conversion and copying operations may be integrated into broader application lifecycle management workflows, allowing for seamless migration of virtual machines between heterogeneous providers as part of deployment, scaling, or resource optimization processes.

Agents 504 (including a source agent 504S and a destination agent 504D for, respectively, the source computing resource 104S and the destination computing resource 104D) may be used to facilitate communication and management between the management platform 106 and computing resources 104. An agent 504 may be a software component installed on individual computing resources 104, such as virtual machines, containers, or physical servers. In some aspects, the agent 504 may be a system process running on a computing device (e.g., a physical or virtual host). The agent 504 may establish an outbound network connection to the management platform 106. The agent 504 may receive commands from the management platform 106 and execute them, enabling remote management tasks such as software installation or configuration changes. The agent 504 may also send responses back to the management platform 106 after executing these commands. In some implementations, the agent 504 may have specialized capabilities, such as Kubernetes awareness, allowing for management of container orchestration environments.

The management platform 106 may receive a request to copy the virtual disk image 502 from the source computing resource 104S to the destination computing resource 104D. The request may be part of a service request received through a user interface or programming interface. In response to this request, the management platform 106 may initiate the copying of the virtual disk image 502 by sending a command to the destination agent 504D. The destination agent 504D may then communicate with the source agent 504S to begin streaming the virtual disk image 502 to the destination computing resource 104D. The source computing resource 104S and destination computing resource 104D may be provider-specific computing resources, potentially using different virtualization technologies or cloud platforms. As the virtual disk image 502 is streamed from the source computing resource104S to the destination computing resource 104D, the destination agent 504D may perform conversion of the virtual disk image 502 from a source format to a destination format.

The destination agent 504D may convert the virtual disk image 502 from a source virtual disk format (used by the source computing resource 104S) to a destination virtual disk format (used by the destination computing resource 104D) while copying the virtual disk image 502. The destination virtual disk format may be different than the source virtual disk format. The virtual disk image 502 includes data blocks. In some aspects, the data blocks may contain the actual data stored in the virtual disk, such as file system structures, application data, and operating system files. The size and organization of these data blocks may vary depending on the specific virtual disk format being used. In some cases, the data blocks may be compressed or encrypted within the virtual disk image 502. The destination agent 504D may process these data blocks during the conversion, potentially decompressing, decrypting, or otherwise transforming them as needed to match the requirements of the destination virtual disk format.

The data blocks in the virtual disk image 502 may have logical locations within the virtual disk structure. The virtual disk image 502 may include metadata, which maps the logical locations of the data blocks to their physical locations within the virtual disk image 502. In some aspects, the source virtual disk format may be a tail-indexed format, where metadata is stored at the end of the virtual disk image 502. This tail-indexed structure may allow the virtual disk image 502 to be quickly exported from the destination computing resource 104D with low processing overhead. However, using the index to convert the virtual disk image 502 to the destination virtual disk format would require the whole virtual disk image 502 to be streamed before conversion can begin. To address this challenge and optimize efficiency and accuracy, the destination agent 504D may attempt to infer the block locations and perform conversion of the virtual disk image 502 during the streaming process. The destination agent 504D may subsequently utilize the metadata to verify and validate the conversion upon completion of the transfer.

The conversion process may be performed without needing to stream and store a full copy of the virtual disk image 502 before conversion. This approach may allow for efficient transfer and conversion of the virtual disk image 502 between heterogeneous computing environments. The destination agent 504D may decode the data blocks from the source format to a raw format while streaming them from the source computing resource 104S. Simultaneously, the destination agent 504D may encode the data blocks from the raw format to the destination format while streaming them to a storage location within the destination computing resource 104D. This streaming conversion may reduce network usage by avoiding multiple transfers of the virtual disk image 502. For example, it may avoid scenarios where the entire image must be streamed out from the source computing resource 104S, converted separately, and then streamed again to storage within the destination computing resource 104D. Instead, the conversion may occur in a single streaming transfer between the source and destination.

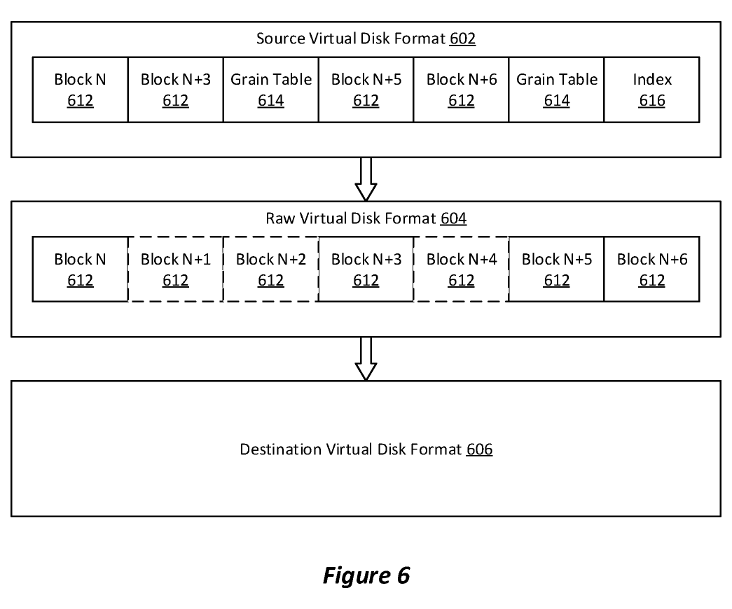

FIG. 6 illustrates a virtual disk format conversion process within the management environment 100, according to some implementations. The conversion process involves decoding a virtual disk image from a source virtual disk format 602 to a raw virtual disk format 604, and then encoding the virtual disk image from the raw virtual disk format 604 to a destination virtual disk format 606. The virtual disk format conversion process will be described in conjunction with the management environment 100 of FIG. 5.

The source virtual disk format 602 may include multiple components. In some aspects, these components may comprise data blocks 612, grain tables 614, and an index 616. The source virtual disk format 602 may organize these components in a specific structure to represent the virtual disk image 502.

The data blocks 612 may contain the data stored in the virtual disk image 502, such as file system structures, application data, and operating system files. The data blocks represent the usable storage space allocated to a virtual machine. The size of each data block 612 may vary depending on the specific source virtual disk format 602, but typical sizes include 512 bytes, 4 kilobytes, or larger. The data blocks 612 may be organized in a logical structure that mimics a physical hard drive, allowing the virtual machine's operating system to interact with the virtual disk as if it were a physical storage device.

A grain table 614 may store metadata about a group of data blocks 612, potentially including information about their locations within the virtual disk image 502. These grain tables 614 may serve as intermediate indexing structures for the data blocks 612. Each grain table 614 corresponds to a preceding range of data blocks 612, providing an efficient way to locate and access data within the virtual disk image 502. The grain tables 614 may contain information such as the positions of data blocks 612, their sizes, and whether they contain actual data or represent empty space. This structure may allow for more efficient random access to specific portions of the virtual disk image 502 without needing to scan the entire file. In some virtual disk formats, such as VMware's VMDK, the grain tables 614 are placed at regular intervals throughout the virtual disk image 502. Each grain table 614 may index the preceding group of data blocks 612. Each group of data blocks 612 and its corresponding grain table 614 may (or may not) have a predetermined number of data blocks 612.

The index 616 may provide a map of the grain tables 614 within the virtual disk image 502. When the source virtual disk format 602 is a tail-indexed structure, the index 616 is located at the end of the virtual disk image 502, and serves as a master directory for the entire disk structure. It contains information about the locations of the grain tables 614 throughout the virtual disk image 502. A data block 612 within a virtual disk image 502 may be located by searching the index 616 for a corresponding grain table 614, and then searching that grain table 614 for the desired data block 612. When attempting to convert or transfer the virtual disk image 502, accessing the index 616 would require reading the entire file to its end, which may be inefficient for large disk images.

To conserve storage and network resources, a virtual disk image 502 in the source virtual disk format 602 may not contain all possible data blocks 612 that could theoretically exist within the allocated disk space. Instead, the virtual disk image 502 may only include data blocks 612 that contain actual data, omitting unused or empty blocks. This approach, often referred to as thin provisioning or sparse allocation, may reduce the storage space required for the virtual disk image 502 in the source virtual disk format 602. When a data block 612 is written to for the first time, it may be allocated and added to the virtual disk image 502. Blocks that have not yet been written to may not be present in the virtual disk image 502. This space-saving technique may be particularly beneficial in environments where large portions of the allocated disk space remain unused. The grain tables 614 and index 616 may keep track of which blocks are actually present in the image, allowing a virtual machine to efficiently manage and access the data. During the conversion process, these potentially missing data blocks 612 may need to be accounted for, by generating appropriate empty blocks in the destination format as required.

The raw virtual disk format 604 may be an intermediate, expanded representation of the virtual disk image 502, where the data blocks 612 are arranged sequentially, potentially without metadata structures (such as the grain tables 614 and the index 616) present in the source virtual disk format 602. Unlike the potentially sparse or thin-provisioned source virtual disk format 602, the raw virtual disk format 604 may include all potential data blocks 612, including those that were not explicitly present in the source virtual disk format 602. Specifically, the raw virtual disk format 604 may include blank or empty data blocks 612. During the decoding process, the source virtual disk format 602 is expanded into this raw format, potentially generating placeholder data for any missing or unallocated data blocks 612. This expansion may result in a larger but more uniform representation of the virtual disk image 502, which can be encoded to any desired destination virtual disk format 606. Once in the raw virtual disk format 604, the virtual disk data may be more easily manipulated and processed. The destination virtual disk format 606 may (or may not) support thin provisioning or sparse allocation depending on the specific requirements of the destination environment.

The data blocks 612 may be located at different positions within the raw virtual disk format 604 compared to their original locations in the source virtual disk format 602. The destination agent 504D may predict the locations of the data blocks 612 within the raw virtual disk format 604 of the virtual disk image 502 when decoding the virtual disk image 502. This prediction is based on the structural characteristics of the source virtual disk format 602, and includes analyzing patterns in the arrangement of the data blocks 612 and the grain tables 614 within the source virtual disk format 602, without needing to access the index 616 located at the end of the source virtual disk format 602 of the virtual disk image 502. This method may allow for a more efficient conversion process by utilizing the structure of the source virtual disk format 602 to guide the transformation of data into the raw virtual disk format 604.

During the decoding process, the destination agent 504D may identify gaps between consecutive ones of the data blocks 612 from the source virtual disk format 602. The destination agent 504D determines the sizes of the gaps based on the block numbers of the consecutive data blocks 612. Such gaps may represent areas of the virtual disk that were allocated but unused in the source virtual disk format 602. To maintain the integrity and continuity of the virtual disk in the raw format, the destination agent 504D generates placeholder data to fill these gaps. Specifically, the destination agent 504D generates new, blank data blocks 612 corresponding to the gaps for the raw virtual disk format 604. The destination agent 504D may generate the placeholder data by writing zeros to the created data blocks 612. The size of the placeholder data corresponds to the size of the gaps, so that the spatial relationships between data blocks 612 are preserved in the transition to the raw virtual disk format 604.

In the example of FIG. 6, data blocks N+1, N+2, and N+4 are not present in the source virtual disk format 602. When decoding to the raw virtual disk format 604, the destination agent 504D creates blank data blocks N+1 and N+2 to fill the gap between data blocks N and N+3. Likewise, the destination agent 504D creates a blank data block N+4 to fill the gap between data blocks N+3 and N+5. After this process, the raw virtual disk format 604 contains a complete and contiguous sequence of data from blocks N to N+6, even though some of these data blocks 612 were not present in the source virtual disk format 602. The creation of these placeholder blocks may allow the raw virtual disk format 604 to maintain proper block ordering and sizing, which may be important for subsequent encoding into the destination virtual disk format 606.

The destination agent 504D utilizes a predictive approach to identify and process data blocks 612 during the streaming conversion. The destination agent 504D may read and buffer a predetermined number of data blocks 612, which may correspond to a certain amount of data, for example, about 33 megabytes. As it processes these blocks, the destination agent 504D may attempt to identify a grain table 614 following the buffered data blocks 612. To distinguish a grain table 614 from regular data blocks 612, the destination agent 504D may analyze a portion of the potential grain table data, such as the first few kilobytes. For instance, this may involve examining the first 2 kilobytes, which could correspond to a certain number of blocks, such as four 512-byte blocks. The destination agent 504D may compare this data to an array of numbers corresponding to the data blocks 612 that have been read so far. If the potential grain table data matches this array of numbers, the destination agent 504D may identify it as a grain table 614 rather than a data block 612. Once a grain table 614 is identified, the destination agent 504D may use it to verify the locations and ordering of the preceding data blocks 612 in the raw virtual disk format 604.

This process of reading data blocks 612, identifying grain tables 614, and verifying block locations may continue iteratively throughout the streaming of the virtual disk image 502. As the destination agent 504D progresses through the image, it may maintain an array of the locations where grain tables 614 have been found. When the destination agent 504D encounters what appears to be another grain table 614, it may compare the contents against this array of known grain table locations. If the contents match this array, the destination agent 504D may identify this as the grain directory. The destination agent 504D may then use the grain directory to verify the locations and integrity of all previously identified grain tables 614, providing an additional layer of validation for the entire conversion process.

To enhance the efficiency of the decoding process, the destination agent 504D may buffer a predetermined number of the data blocks 612 and the associated grain table 614 before beginning performing the actual decoding from the source virtual disk format 602 to the raw virtual disk format 604. In some aspects, this buffering may enable the decoding process by providing sufficient context to interpret the structure of the virtual disk image 502. The amount of buffering may be relatively small compared to the overall size of the virtual disk image 502.

In some implementations, the destination agent 504D failing to find a grain table 614 during the conversion process indicates failure of the predictive decoding process. When the predictive process fails, the destination agent 504D may fall back by reading the index 616 at the end of the virtual disk image 502, extracting the locations of the data blocks 612 from this metadata, and restarting the conversion process using these extracted block locations. This restart may occur from the beginning of the virtual disk image 502 or from a portion that was successfully converted before the failure to find the grain table 614. Reading to the end of the virtual disk image 502 to obtain the index 616 may require streaming the entire file before restarting conversion, but ensures that the conversion process can be completed even if the predictive method fails, providing a robust fallback mechanism.

The destination agent 504D may encode the data blocks 612 from the raw virtual disk format 604 to the destination virtual disk format 606 while streaming the data blocks 612 to the destination computing resource 104D. This encoding process may involve restructuring the raw data into the format required by the destination virtual disk format 606, which may include creating new metadata structures appropriate for the destination format.

The conversion process from the source virtual disk format 602 to the destination virtual disk format 606 via the raw virtual disk format 604 may occur in a pipelined manner, allowing for efficient and simultaneous processing of the virtual disk image 502. As the destination agent 504D reads and decodes data blocks 612 from the source virtual disk format 602 into the raw virtual disk format 604, it may also begin encoding those data blocks 612 into the destination virtual disk format 606. This pipelined approach may allow the conversion to proceed without needing to store the entire disk (in the raw virtual disk format 604) in memory or on disk. Instead, small portions of the raw format may be held in a buffer, processed, and then discarded as the conversion progresses. By pipelining the decoding and encoding operations, the destination agent 504D may reduce the overall storage footprint of the conversion process and potentially decrease the total time required for the transfer. This streaming conversion method may be particularly beneficial when dealing with large virtual disk images, as it may allow the conversion process to begin outputting data in the destination virtual disk format 606 before the entire virtual disk image 502 has been read.

The conversion process from the source virtual disk format 602 to the destination virtual disk format 606 via the raw virtual disk format 604 may allow for efficient transfer and conversion of the virtual disk image 502 between heterogeneous computing environments. By predicting block locations and performing conversion during streaming, the destination agent 504D may target a desired disk format without needing to stream and store a full copy of the virtual disk image 502 before conversion.

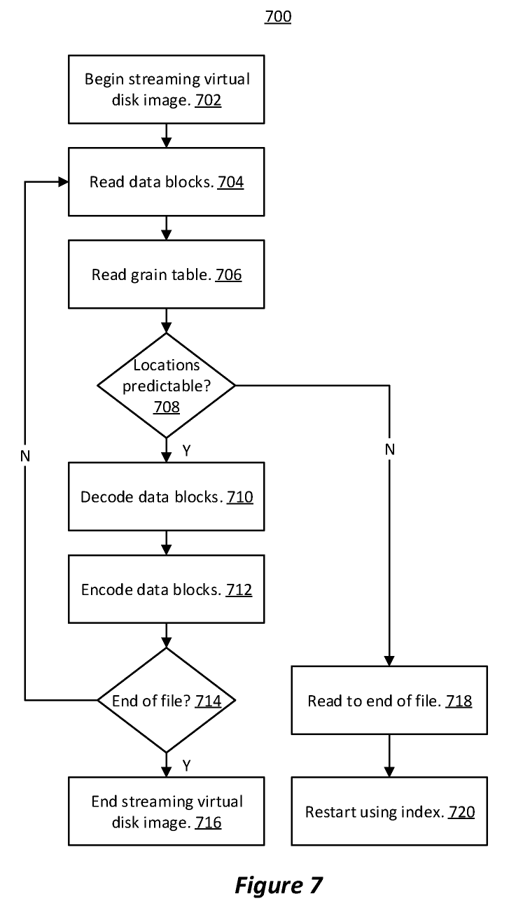

FIG. 7 illustrates a flowchart of a virtual disk image converting method 700, according to some implementations. The virtual disk image converting method 700 will be described in conjunction with FIGS. 5-6. The virtual disk image converting method 700 may be performed within the management environment 100, specifically by the destination agent 504D of the destination computing resource 104D.

In step 702, the destination agent 504D begins the streaming of the virtual disk image 502 in response to a command from the management platform 106. The streaming occurs from the source computing resource 104S to the destination computing resource 104D.

In step 704, the destination agent 504D reads data blocks 612 from the virtual disk image 502 that is being streamed. The destination agent 504D may read the data blocks 612 from the virtual disk image 502 in the source virtual disk format 602.

In step 706, the destination agent 504D reads a grain table 614 from the virtual disk image 502 that is being streamed. In some cases, the destination agent 504D may search for the grain table 614 as it reads the data blocks 612 from the virtual disk image 502. The destination agent 504D may identify potential grain table data by analyzing a predetermined number of bytes in the virtual disk image 502. For example, the destination agent 504D may analyze the first few kilobytes of data following a data block 612 to determine if the next element in the stream is another data block 612 or a grain table 614.

The destination agent 504D may compare the potential grain table data to an array of numbers corresponding to the data blocks 612 read from the virtual disk image 502. The destination agent 504D may maintain the array of numbers as it reads the data blocks 612 (in step 704). In some cases, the destination agent 504D may identify the potential grain table data as the grain table 614 in response to the potential grain table data matching the array of numbers corresponding to the data blocks 612.

In step 708, the destination agent 504D determines whether locations of the data blocks 612 can be predicted. The locations may be predictable if the grain table 614 was found.

In step 710, if the locations of the data blocks 612 are predictable, the destination agent 504D decodes the data blocks 612 into the raw virtual disk format 604. The destination agent 504D may verify the locations of the data blocks 612 based on the grain table 614 after finding the grain table 614. This may include filling gaps with new blank data blocks 612 to maintain proper block ordering and sizing in the raw virtual disk format 604.

In step 712, the destination agent 504D encodes the data blocks 612. The destination agent 504D may encode the decoded data blocks 612 into the destination virtual disk format 606. In some implementations, the encoding step may be pipelined after the decoding step, allowing for efficient and simultaneous processing of the virtual disk image 502. As the destination agent 504D decodes data blocks 612 from the source virtual disk format 602 into the raw virtual disk format 604, it may begin encoding those data blocks 612 into the destination virtual disk format 606. The destination virtual disk format 606 may be any desired format compatible with the destination computing resource 104D. For example, it may be a format used by a different hypervisor or cloud platform than the source virtual disk format 602.

In step 714, the destination agent 504D checks if the end of the file has been reached. If the end of file has not been reached, the destination agent 504D returns to step 704 to read more data blocks 612. In some implementations, the destination agent 504D may search for an index 616 (e.g., grain directory) in the virtual disk image 502. The destination agent 504D may verify accuracy of the grain tables 614 based on the index 616 (e.g., grain directory) in response to finding the grain directory. In some aspects, finding the grain directory may indicate that the end of file has been reached. If the end of file has been reached, the streaming of the virtual disk image 502 may end.

In step 716, if the end of file has been reached, the streaming of the virtual disk image 502 ends. At this point, the conversion process may be complete and the virtual disk image 502 may be fully transferred to the destination computing resource 104D in the destination virtual disk format 606. The management platform 106 may then update its records to reflect the successful transfer and conversion of the virtual disk image 502.

In step 718, if at step 708 the locations of the data blocks (in the raw virtual disk format 604) cannot be predicted, the destination agent 504D reads to the end of the file. The destination agent 504D may read the index 616 at the end of the virtual disk image 502 in response to failing to find a grain table 614.

In step 720, after reading to the end of the virtual disk image 502, the destination agent 504D restarts using the index 616 found at the end of the file. The destination agent 504D may extract the locations of the data blocks 612 from the index 616. In some cases, the destination agent 504D may restart the converting of the virtual disk image 502 using the locations of the data blocks 612 extracted from the index 616.

In some cases, the destination agent 504D may restart the converting of the virtual disk image 502 from the beginning of the virtual disk image 502. In some cases, the destination agent 504D may restart the converting of the virtual disk image 502 from a portion of the virtual disk image 502 that was successfully converted before failing to find a grain table 614. The fallback conversion process for the virtual disk image 502 may skip portions of the virtual disk image 502 that were successfully converted on a first pass.

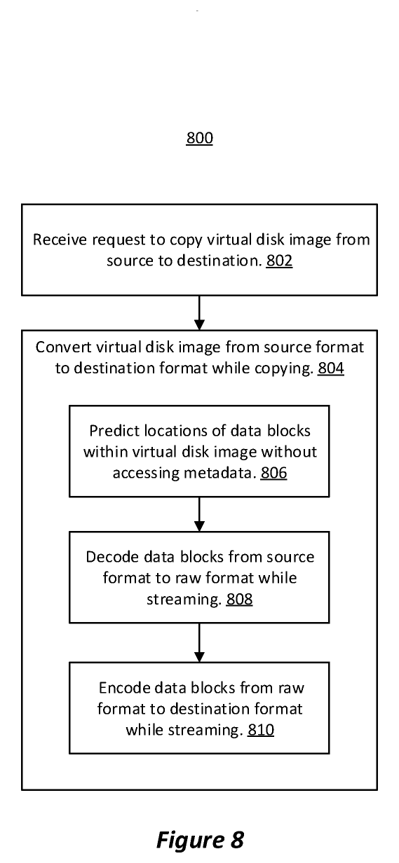

FIG. 8 illustrates a flowchart of a virtual disk image converting method 800, according to some implementations. The virtual disk image converting method 800 will be described in conjunction with FIGS. 5-6. The virtual disk image converting method 800 may be performed within the management environment 100, specifically by the destination agent 504D of the destination computing resource 104D.

The destination agent 504D may perform a step 802 of receiving a request to copy a virtual disk image 502 from a source provider-specific computing resource 104S to a destination provider-specific computing resource 104D. This request may be part of a service request from an end-user to perform self-service provisioning or management through the management platform 106. In some cases, the request to the destination agent 504D may be generated as part of a migration or orchestration process in response to the service request. The management platform 106 may initiate this request as part of a broader orchestration or management operation, such as migrating virtual machines between different cloud environments or hypervisors.

The destination agent 504D may perform a step 804 of converting the virtual disk image 502 from a source virtual disk format 602 to a destination virtual disk format 606 while copying the virtual disk image 502. The destination virtual disk format 606 may be different than the source virtual disk format 602. In some aspects, the source virtual disk format 602 may define metadata, such as an index 616, at the end of the virtual disk image 502. This tail-indexed structure may allow for quick export of the virtual disk image 502 but presents challenges for streaming conversion.

The destination agent 504D may perform a step 806 of predicting locations of data blocks 612 within the virtual disk image 502 based on structural characteristics of the source virtual disk format 602 without accessing the metadata at the end of the virtual disk image 502. This prediction may involve reading the data blocks 612 from the virtual disk image 502, inferring the locations of the data blocks 612 based on the structural characteristics of the source virtual disk format 602, searching for a grain table 614 after the data blocks 612 in the virtual disk image 502, and verifying the locations of the data blocks 612 based on the grain table 614 in response to finding the grain table 614.

In some implementations, the destination agent 504D may further search for an index 616 (e.g., grain directory) after the grain table 614 in the virtual disk image 502 and verify accuracy of the grain table 614 based on the grain directory in response to finding the grain directory. When searching for the grain table 614, the destination agent 504D may identify potential grain table data by analyzing a predetermined number of bytes in the virtual disk image 502, compare the potential grain table data to an array of numbers corresponding to the data blocks 612 read from the virtual disk image 502, and identify the potential grain table data as the grain table 614 in response to the potential grain table data matching the array of numbers corresponding to the data blocks 612.

The destination agent 504D may perform a step 808 of decoding the data blocks 612 from the source virtual disk format 602 to a raw virtual disk format 604 while streaming the data blocks 612 from the source provider-specific computing resource 104S. The data blocks 612 may be decoded based on the predicted locations of the data blocks 612 within the virtual disk image 502. In some cases, the destination agent 504D may identify a gap between consecutive ones of the data blocks 612, determine a size of the gap based on block numbers of the consecutive ones of the data blocks 612, and generate placeholder data to fill the gap based on the size of the gap.

When decoding the data blocks 612, the destination agent 504D may buffer a predetermined number of the data blocks 612. This buffering may enhance the efficiency of the decoding process by providing sufficient context to interpret the structure of the virtual disk image 502.

The destination agent 504D may perform a step 810 of encoding the data blocks 612 from the raw virtual disk format 604 to the destination virtual disk format 606 while streaming the data blocks 612 to the destination provider-specific computing resource 104D. This encoding process may involve restructuring the raw data into the format required by the destination virtual disk format 606, which may include creating new metadata structures appropriate for the destination format.

If the destination agent 504D fails to find a grain table 614 (in step 806), it may read the metadata at the end of the virtual disk image 502, extract the locations of the data blocks 612 from the metadata, and restart the converting of the virtual disk image 502 using the locations of the data blocks 612 extracted from the metadata. The converting may be restarted from the beginning of the virtual disk image 502 or from a portion of the virtual disk image 502 that was successfully converted before failing to find the grain table 614. This fallback mechanism ensures that the conversion process can be completed even if the predictive method fails.

The conversion process from the source virtual disk format 602 to the destination virtual disk format 606 via the raw virtual disk format 604 may occur in a pipelined manner, allowing for efficient and simultaneous processing of the virtual disk image 502. This streaming conversion method may be particularly beneficial when dealing with large virtual disk images, as it may allow the conversion process to begin outputting data in the destination virtual disk format 606 before the entire virtual disk image 502 has been read. By streamlining the transfer and conversion of virtual disk images, this method helps organizations manage and orchestrate their diverse computing resources, improving operational efficiency in complex IT landscapes and enabling easier migration between different hypervisor platforms.

The streaming conversion method for virtual disk images enables efficient transfer and conversion of the disk images between heterogeneous computing environments without requiring full storage of the disk images before conversion. By predicting data block locations based on structural characteristics and performing on-the-fly decoding and encoding, the system may reduce storage and network resource usage during virtual machine migrations between providers. This approach may allow organizations to more easily move workloads between different cloud providers or hypervisors, potentially improving flexibility and reducing vendor lock-in in multi-cloud and hybrid cloud architectures.

Although this disclosure describes or illustrates particular operations as occurring in a particular order, this disclosure contemplates the operations occurring in any suitable order. Moreover, this disclosure contemplates any suitable operations being repeated one or more times in any suitable order. Although this disclosure describes or illustrates particular operations as occurring in sequence, this disclosure contemplates any suitable operations occurring at substantially the same time, where appropriate. Any suitable operation or sequence of operations described or illustrated herein may be interrupted, suspended, or otherwise controlled by another process, such as an operating system or kernel, where appropriate. The acts can operate in an operating system environment or as stand-alone routines occupying all or a substantial part of the system processing.

While this disclosure has been described with reference to illustrative implementations, this description is not intended to be construed in a limiting sense. Various modifications and combinations of the illustrative implementations, as well as other implementations of the disclosure, will be apparent to persons skilled in the art upon reference to the description. It is therefore intended that the appended claims encompass any such modifications or implementations.

What is claimed is:

1. A computer-implemented method comprising:
receiving a request to copy a virtual disk image from a source provider-specific computing resource to a destination provider-specific computing resource; and
converting the virtual disk image from a source virtual disk format to a destination virtual disk format while copying the virtual disk image, the destination virtual disk format being different than the source virtual disk format, the source virtual disk format defining metadata at the end of the virtual disk image, wherein converting the virtual disk image comprises:
predicting locations of data blocks within the virtual disk image based on structural characteristics of the source virtual disk format without accessing the metadata at the end of the virtual disk image;
decoding the data blocks from the source virtual disk format to a raw virtual disk format while streaming the data blocks from the source provider-specific computing resource, wherein the data blocks are decoded based on the predicted locations of the data blocks within the virtual disk image; and
encoding the data blocks from the raw virtual disk format to the destination virtual disk format while streaming the data blocks to the destination provider-specific computing resource.

2. The method of claim 1, wherein predicting the locations of the data blocks comprises:
reading the data blocks from the virtual disk image;
inferring the locations of the data blocks based on the structural characteristics of the source virtual disk format;
searching for a grain table after the data blocks in the virtual disk image; and
verifying the locations of the data blocks based on the grain table in response to finding the grain table.

3. The method of claim 2, wherein predicting the locations of the data blocks further comprises:
searching for a grain directory after the grain table in the virtual disk image; and
verifying accuracy of the grain table based on the grain directory in response to finding the grain directory.

4. The method of claim 2, wherein searching for the grain table comprises:
identifying potential grain table data by analyzing a predetermined number of bytes in the virtual disk image;
comparing the potential grain table data to an array of numbers corresponding to the data blocks read from the virtual disk image; and
identifying the potential grain table data as the grain table in response to the potential grain table data matching the array of numbers corresponding to the data blocks.

5. The method of claim 2, wherein converting the virtual disk image further comprises:
reading the metadata at the end of the virtual disk image in response to failing to find the grain table;
extracting the locations of the data blocks from the metadata; and
restarting the converting of the virtual disk image using the locations of the data blocks extracted from the metadata.

6. The method of claim 5, wherein the converting of the virtual disk image is restarted from the beginning of the virtual disk image.

7. The method of claim 5, wherein the converting of the virtual disk image is restarted from a portion of the virtual disk image that was successfully converted before failing to find the grain table.

8. The method of claim 2, wherein converting the virtual disk image further comprises:
buffering a predetermined number of the data blocks prior to decoding the data blocks from the source virtual disk format to the raw virtual disk format.

9. The method of claim 1, wherein decoding the data blocks from the source virtual disk format comprises:
identifying a gap between consecutive ones of the data blocks, wherein the gap corresponds to unused data blocks in the source virtual disk format;
determining a size of the gap based on block numbers of the consecutive ones of the data blocks; and
generating placeholder data to fill the gap based on the size of the gap.

10. A computer system comprising:
a source provider-specific computing resource; and
a destination provider-specific computing resource comprising a destination agent configured to:
receive a request to copy a virtual disk image from the source provider-specific computing resource to the destination provider-specific computing resource; and
convert the virtual disk image from a source virtual disk format to a destination virtual disk format while copying the virtual disk image, the destination virtual disk format being different than the source virtual disk format, the source virtual disk format defining metadata at the end of the virtual disk image, wherein converting the virtual disk image comprises:
predicting locations of data blocks within the virtual disk image based on structural characteristics of the source virtual disk format without accessing the metadata at the end of the virtual disk image;
decoding the data blocks from the source virtual disk format to a raw virtual disk format while streaming the data blocks from the source provider-specific computing resource, wherein the data blocks are decoded based on the predicted locations of the data blocks within the virtual disk image; and
encoding the data blocks from the raw virtual disk format to the destination virtual disk format while streaming the data blocks to the destination provider-specific computing resource.

11. The computer system of claim 10, wherein predicting the locations of the data blocks comprises:
reading the data blocks from the virtual disk image;
inferring the locations of the data blocks based on the structural characteristics of the source virtual disk format;
searching for a grain table after the data blocks in the virtual disk image; and
verifying the locations of the data blocks based on the grain table in response to finding the grain table.

12. The computer system of claim 11, wherein predicting the locations of the data blocks further comprises:
searching for a grain directory after the grain table in the virtual disk image; and
verifying accuracy of the grain table based on the grain directory in response to finding the grain directory.

13. The computer system of claim 11, wherein searching for the grain table comprises:
identifying potential grain table data by analyzing a predetermined number of bytes in the virtual disk image;
comparing the potential grain table data to an array of numbers corresponding to the data blocks read from the virtual disk image; and
identifying the potential grain table data as the grain table in response to the potential grain table data matching the array of numbers corresponding to the data blocks.

14. The computer system of claim 11, wherein the destination agent is further configured to:
read the metadata at the end of the virtual disk image in response to failing to find the grain table;
extract the locations of the data blocks from the metadata; and
restart the converting of the virtual disk image using the locations of the data blocks extracted from the metadata.

15. The computer system of claim 14, wherein the converting of the virtual disk image is restarted from the beginning of the virtual disk image.

16. The computer system of claim 14, wherein the converting of the virtual disk image is restarted from a portion of the virtual disk image that was successfully converted before failing to find the grain table.

17. The computer system of claim 11, wherein the destination agent is further configured to:
buffer a predetermined number of the data blocks prior to decoding the data blocks from the source virtual disk format to the raw virtual disk format.

18. The computer system of claim 10, wherein decoding the data blocks from the source virtual disk format comprises:
identifying a gap between consecutive ones of the data blocks, wherein the gap corresponds to unused data blocks in the source virtual disk format;
determining a size of the gap based on block numbers of the consecutive ones of the data blocks; and
generating placeholder data to fill the gap based on the size of the gap.

19. A computer device comprising:
a processor; and
a non-transitory computer-readable medium storing instructions which, when executed by the processor, cause the processor to:
receive a request to copy a virtual disk image from a source provider-specific computing resource to a destination provider-specific computing resource; and
convert the virtual disk image from a source virtual disk format to a destination virtual disk format while copying the virtual disk image, the destination virtual disk format being different than the source virtual disk format, the source virtual disk format defining metadata at the end of the virtual disk image, wherein the instructions to convert the virtual disk image cause the processor to:
predict locations of data blocks within the virtual disk image based on structural characteristics of the source virtual disk format without accessing the metadata at the end of the virtual disk image;
decode the data blocks from the source virtual disk format to a raw virtual disk format while streaming the data blocks from the source provider-specific computing resource, wherein the data blocks are decoded based on the predicted locations of the data blocks within the virtual disk image; and
encode the data blocks from the raw virtual disk format to the destination virtual disk format while streaming the data blocks to the destination provider-specific computing resource.

20. The computer device of claim 19, wherein the request to copy the virtual disk image comprise a service request to orchestrate an application.
